(19) United States
(12) Patent Application Publication
(10) Pub. No.: US 2016/0189705 A1
(43) Pub. Date: Jun. 30, 2016

(54) QUANTITATIVE F0 CONTOUR GENERATING DEVICE AND METHOD, AND MODEL LEARNING DEVICE AND METHOD FOR F0 CONTOUR GENERATION

(71) Applicant: NATIONAL INSTITUTE OF INFORMATION AND COMMUNICATIONS TECHNOLOGY, Tokyo (JP)

(72) Inventors: Jinfu NI, Tokyo (JP); Yoshinori SHIGA, Tokyo (JP)

(73) Assignee: National Institute of Information and Communicatio ns Technology, Tokyo (JP)

(21) Appl. No.: 14/911,189

(22) PCT Filed: Aug. 13, 2014
(86) PCT No.: PCT/JP2014/071392

§ 371 Date: Feb. 9, 2016

(30) Foreign Application Priority Data
Aug. 23, 2013 (JP) 2013-173634

(51) Int. Cl. G10L 13/10; G10L 21/02; G10L 25/18; G10L 13/027; G10L 13/08

(52) U.S. Cl. CPC G10L 13/10; G10L 13/027; G10L 13/086; G10L 25/18; G10L 21/0205

(57) ABSTRACT

[Object] An object is to provide an F0 contour synthesizing device based on statistic model, to clarify correspondence between linguistic information and F0 contour while maintaining accuracy.

[Solution] An HMM learning device includes: a parameter estimating unit representing an F0 contour 133 fitting a continuous F0 contour 132 as a sum of phrase components and accent components and estimating target points of these; and an HMM learning means conducting learning of HMM 139 using the fitted F0 contour as training data. The continuous F0 contour may be decomposed to accent components 134, phrase components 136 and micro-prosody components 138, and separate HMMs 140, 142 and 144 may be trained. Using results of text analysis, accent components, phrase components and micro-prosody components are separately synthesized from HMMs 140, 142 and 144 and the results are synthesized to obtain an F0 contour.

### TECHNICAL FIELD

The present invention relates to a speech synthesis technique and, more specifically, to a technique of synthesizing fundamental frequency contours at the time of speech synthesis.

### BACKGROUND ART

A time-change contour of fundamental frequency of speech (hereinafter referred to as “F0 contour”) is helpful in clarifying separation between sentences, in expressing accented positions and in distinguishing words. The F0 contour also plays an important role to convey non-verbal information such as feelings involved in an utterance. The F0 contour also has a big influence on naturalness of an utterance. Particularly, in order to clarify a point of focus in an utterance and to make clear a sentence structure, it is necessary to utter a sentence with appropriate intonation. An inappropriate F0 contour impairs comprehensibility of synthesized speech. Therefore, how to synthesize a desired F0 contour poses a big problem in the field of speech synthesis.

As a method of synthesizing an F0 contour, a method known as Fujisaki model is disclosed in Non-Patent Literature 1, as listed below.

Fujisaki model is an F0 contour generation process model that quantitatively describes an F0 contour using a small number of parameters. Referring to FIG. 1, the F0 contour generation process model 30 represents an F0 contour as a sum of a phrase component, an accent component and a base component Fb.

The phrase component refers to a component in an utterance, which has a peak rising immediately after the start of a phrase and slowly goes down toward the end of the phrase. The accent component refers to a component represented by local ups and downs corresponding to words.

Referring to the left side of FIG. 1, Fujisaki model represents the phrase component by a response of a phrase control mechanism 42 to phrase command 40 on an impulse generated at the start of a phrase, while the accent component is likewise represented by a response of an accent control mechanism 46 to a step-wise accent command 44. By adding the phrase component, accent component and logₑFb of fundamental component Fb by an adder 48, a logarithmic representation logₑF0(t) of F0 contour 50 is obtained.

In this model, the accent and phrase components have clear correspondences with linguistic and para-linguistic information of an utterance. Further, it is characterized in that a point of focus of a sentence can easily be determined simply by changing a model parameter.

This model, however, suffers from a problem that it is difficult to determine appropriate parameters. In the field of speech technology, with recent development of computers, a method of building a model from huge amount of collected speech data is dominant. In Fujisaki model, it is difficult to automatically obtain model parameters from F0 contours observed in a speech corpus.

By contrast, a typical method of building a model from a huge amount of collected speech data is described in Non-Patent Literature 2, as listed below, in which an HMM (Hidden Marcov Model) is built from F0 contours observed in a speech corpus. According to this method, it is possible to obtain F0 contours in various uttered contexts from a speech corpus and to form a model therefrom. Therefore, this is very important in realizing naturalness and realizing an information conveying function of synthesized speeches.

Referring to FIG. 2, a conventional speech synthesizing system 70 in accordance with this method includes: a model learning unit 80 learning an HMM model for synthesizing F0 contours from a speech corpus; and a speech synthesizer 82 producing, in accordance with the F0 contour obtained by the HMM resulting from the learning, synthesized speech signals 118 corresponding to an input text.

Model learning unit 80 includes: a speech corpus storage device 90 for storing a speech corpus having context labels of phonemes; an F0 extracting unit 92 for extracting F0 from speech signals of each utterance in the speech corpus stored in speech corpus storage device 90; a spectrum parameter extracting unit 94 for extracting, as spectrum parameters, mel-cepstrum parameters from each utterance; and an HMM learning unit 96, for generating a feature vector of each frame, using the F0 contour extracted by F0 extracting unit 92, the label of each phoneme in an utterance corresponding to the F0 contour obtained from speech corpus storage device 90 and the mel-cepstrum parameters given from spectrum parameter extracting unit 94, and when a label sequence consisting of context labels of phonemes as objects of generation is given, conducting statistical learning of HMM such that it outputs a probability that a set of each F0 frequency and mel-cepstrum parameters is output in that frame. Here, the context label refers to a control sign for speech synthesis, and it is a label having various pieces of linguistic information (context) including phonetic environment of the corresponding phoneme.

Speech synthesizer 82 includes: an HMM storage device 110 for storing HMM parameters learned by HMM learning unit 96; a text analyzing unit 112 for performing, when a text as an object of speech synthesis is applied, text-analysis of the text, specifying words in an utterance and phonemes thereof, determining accents, determining pose inserting positions and determining a sentence type, and outputting a label sequence representing the utterance; a parameter generating unit 114 for comparing, when a label sequence is received from text analyzing unit 112, the label sequence with the HMM stored in HMM storage device 110, and generating and outputting a combination having the highest possibility as a combination of an F0 contour and a mel-cepstrum sequence if the original text is to be uttered; and a speech synthesizing unit 116 for synthesizing, in accordance with the F0 contour received from parameter generating unit 114, the speech represented by the mel-cepstrum parameter applied from parameter generating unit 114 and outputting it as synthesized speech signal 118.

Speech synthesizing system 70 as above attains an effect that various F0 contours can be output over a wide context, based on a huge amount of speech data.

### CITATION LIST

### Non Patent Literature

NPL 1: Fujisaki, H., and Hirose, K. (1984), “Analysis of voice fundamental frequency contours for declarative sentences of Japanese,” J. Acoust. Soc. Jpn., 5, 233-242.
NPL 2: Tokuda, K., Masuko, T., Miyazaki, N., and Kobayashi, T. (1999), “Hidden Markov models based on multi-space probability distribution for pitch contour modeling,” Proc. of ICASSP1999, 229-232.
NPL 3: Ni, J. and Nakamura, S. (2007), “Use of Poisson processes to generate fundamental frequency contours”, Proc. of ICASSP2007, 825-828.
NPL 4: Ni, J, Shiga, Y., Kawai, H., and Kashioka, H. (2012), “Resonance-based spectral deformation in HMM-based speech synthesis,” Proc. of ISCSLP2012, 88-92.

### SUMMARY OF INVENTION

### Technical Problem

In an actual utterance, at a boundary of phonemes, for example, slight variation occurs in voice pitch as the manner of utterance changes. This is referred to as micro-prosody. At a boundary between voiced and unvoiced segments, for example, F0 changes abruptly. Though such a change is observed when the speech is processed, it does not have much meaning in auditory perception. In the speech synthesizing system 70 (see FIG. 2) using the HMM described above, F0 contour error increases because of the influence of such micro-prosody. Further, the system also has a problem that its performance is low when it follows F0 change contours over relatively long sections. In addition, it has a problem that the relation between the synthesized F0 contour and the linguistic information is unclear and that it is difficult to set a point of focus (variation in F0 independent of context).

Therefore, an object of the present invention is to provide an F0 contour synthesizing device and method used when an F0 contour is generated from a statistical model, in which the linguistic information clearly corresponds to the F0 contour, while maintaining high accuracy.

Another object of the present invention is to provide a device and method used when an F0 contour is generated from a statistical model, in which the linguistic information clearly corresponds to the F0 contour and which makes it easy to set a point of focus of a sentence, while maintaining high accuracy.

### Solution to Problem

According to a first aspect, the present invention provides a quantitative F0 contour generating device, including: means for generating, for an accent phrase of an utterance obtained by text analysis, accent components of an F0 contour using a given number of target points; means for generating phrase components of the F0 contour using a limited number of target points, by dividing the utterance to groups each including one or more accent phrases, in accordance with linguistic information including an utterance structure; and means for generating an F0 contour based on the accent components and the phrase components.

Each accent phrase is described by three or four target points. Of the four points, two are low targets representing portions of low frequency of the F0 contour of accent phrase, and the remaining one is a high target representing a portion of high frequency of the F0 contour. If there are two high targets, they may have the same magnitude.

The means for generating an F0 contour generates a continuous F0 contour.

According to a second aspect, the present invention provides a quantitative F0 contour generating method, including the steps of: generating, for an accent phrase of an utterance obtained by text analysis, accent components of an F0 contour using a given number of target points; generating phrase components of the F0 contour using a limited number of target points, by dividing the utterance to groups each including one or more accent phrases, in accordance with linguistic information including an utterance structure; and generating an F0 contour based on the accent components and the phrase components.

According to a third aspect, the present invention provides a quantitative F0 contour generating device, including: model storage means for storing parameters of a generation model for generating target parameters of phrase components of an F0 contour and a generation model for generating target parameters of accent components of the F0 contour; text analyzing means for receiving an input of a text as an object of speech synthesis, for conducting text analysis and outputting a sequence of control signs for speech synthesis; phrase component generating means for generating phrase components of the F0 contour by comparing the sequence of control signs output from the text analyzing means with the generation model for generating phrase components; accent component generating means for generating accent components by comparing the sequence of control signs output from the text analyzing means with the generation model for generating accent components; and F0 contour generating means for generating an F0 contour by synthesizing the phrase components generated by the phrase component generating means and the accent components generated by the accent component generating means.

The model storage means may further store parameters for a generation model for estimating micro-prosody components of the F0 contour. Here, the F0 contour generating device further includes a micro-prosody component output means, for outputting, by comparing the sequence of control signs output from the text analyzing means with the generation model for generating the micro-prosody components, the micro-prosody components of the F0 contour. The F0 contour generating means includes means for generating an F0 contour by synthesizing the phrase components generated by the phrase component generating means, the accent components generated by the accent component generating means, and the micro-prosody components.

According to a fourth aspect, the present invention provides a quantitative F0 contour generating method, using model storage means for storing parameters of a generation model for generating target parameters of phrase components of an F0 contour and a generation model for generating target parameters of accent components of the F0 contour, including the steps of: text analyzing step of receiving an input of a text as an object of speech synthesis, conducting text analysis and outputting a sequence of control signs for speech synthesis; phrase component generating means for generating phrase components of the F0 contour by comparing the sequence of control signs output at the text analyzing step with the generation model for generating phrase components stored in the storage means; accent component generating step of generating accent components of the F0 contour by comparing the sequence of control signs output at the text analyzing step with the generation model for generating accent components stored in the storage means; and F0 contour generating step of generating an F0 contour by synthesizing the phrase components generated at the phrase component generating step and the accent components generated at the accent component generating step.

According to a fifth aspect, the present invention provides a model learning device for F0 contour generation, including: F0 contour extracting means for extracting an F0 contour from a speech data signal; parameter estimating means for estimating target parameters representing phrase components and target parameters representing accent components, for representing an F0 contour fitting the extracted F0 contour by superposition of phrase components and accent components; and model learning means, performing F0 generation model learning, using a continuous F0 contour represented by the target parameters of phrase components and the target parameters of accent components estimated by the parameter estimating means as training data.

The F0 generation model may include a generation model for generating phrase components and a generation model for generating accent components. The model learning means includes a first model learning means for performing learning of the generation model for generating phrase components and the generation model for generating accent components, using, as training data, a time change contour of phrase components represented by target parameters of the phrase components and a time change contour of accent components represented by target parameters of the accent components, estimated by the parameter estimating means.

The model learning device may further include a second model learning means, separating the micro-prosody components from the F0 contour extracted by the F0 contour extracting means, and using the micro-prosody components as training data, for learning the generation model for generating the micro-prosody components.

According to a sixth aspect, the present invention provides a model learning method for F0 contour generation, including the steps of: F0 contour extracting step of extracting an F0 contour from a speech data signal; parameter estimating step of estimating target parameters representing phrase components and target parameters representing accent components, for representing an F0 contour fitting the extracted F0 contour by superposition of phrase components and accent components; and model learning step of performing F0 generation model learning, using a continuous F0 contour represented by the target parameters of phrase components and the target parameters of accent components estimated by the parameter estimating means as training data.

The F0 generation model may include a generation model for generating phrase components and a generation model for generating accent components. The model learning step includes the step of performing learning of the generation model for generating phrase components and the generation model for generating accent components, using, as training data, a time change contour of phrase components represented by target parameters of the phrase components and a time change contour of accent components represented by target parameters of the accent components, estimated at the parameter estimating step.

### BRIEF DESCRIPTION OF DRAWINGS

FIG. 1 is a schematic diagram showing a concept of the F0 contour generation process model in accordance with Non-Patent Literature 1.

FIG. 2 is a block diagram showing a configuration of a speech synthesizing system in accordance with Non-Patent Literature 2.

FIG. 3 is a block diagram schematically showing an F0 contour generation process in accordance with the first and second embodiments of the present invention.

FIG. 4 is a schematic diagram showing a method of representing accent and phrase components of an F0 contour with target points and synthesizing these to generate an F0 contour.

FIG. 5 is a flowchart representing a control structure of a program for determining target points of accent and phrase components.

FIG. 6 is a graph showing an observed discontinuous F0 contour, a continuous F0 contour fitted with the contour, and phrase and accent components representing these.

FIG. 7 is a block diagram showing a configuration of a speech synthesizing system in accordance with the first embodiment of the present invention.

FIG. 8 shows results of subjective evaluation test for the generated F0 contour.

FIG. 9 is a block diagram showing a configuration of a speech synthesizing system in accordance with the second embodiment of the present invention.

FIG. 10 shows an appearance of a computer system for realizing the embodiments of the present invention.

FIG. 11 is a block diagram showing a hardware configuration of a computer of the computer system of which appearance is shown in FIG. 10.

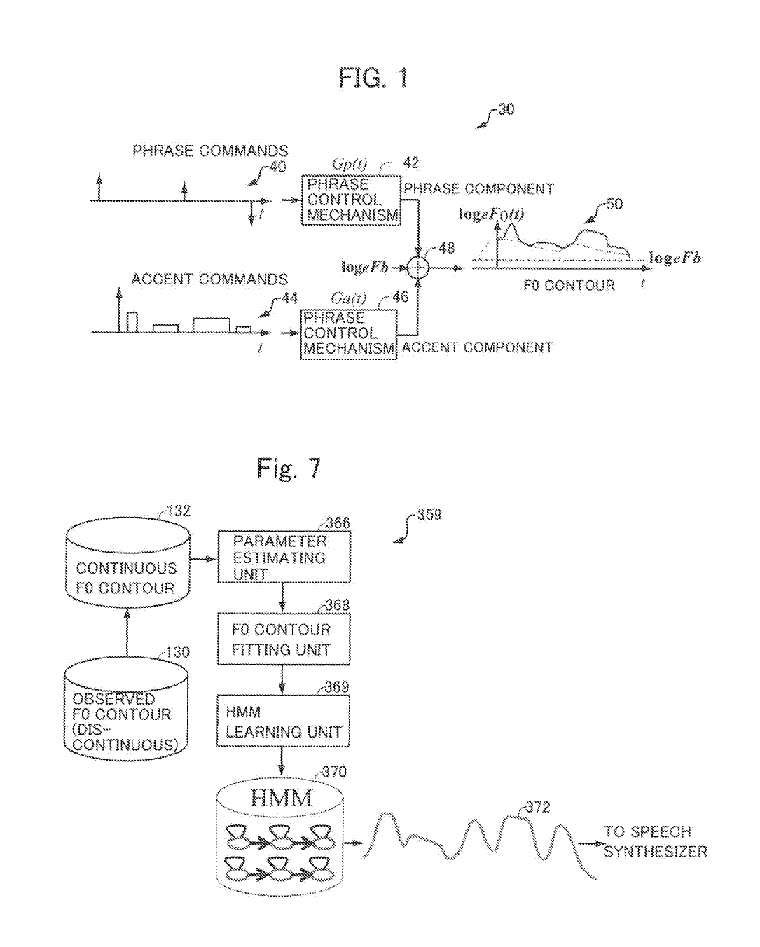

### DESCRIPTION OF EMBODIMENTS

In the following description and in the drawings, the same components are denoted by the same reference characters. Therefore, detailed description thereof will not be repeated. In the following embodiments, an HMM is used as an F0 contour generating model. It is noted, however, that the model is not limited to HMM. By way of example, CART (Classification and Regression Tree) modeling (L. Breiman, J. H. Friedman, R. A. Olshen and C. J. Stone, “Classification and Regression Trees”, Wadsworth (1984)), modeling based on Simulated annealing (S. Kirkpatrick, C. D. Gellatt, Jr., and M. P. Vecchi, “Optimization by simulated annealing,” IBM Thomas J. Watson Research Center, Yorktown Heights, N.Y., 1982.) and the like may be used.

[Basic Concept]

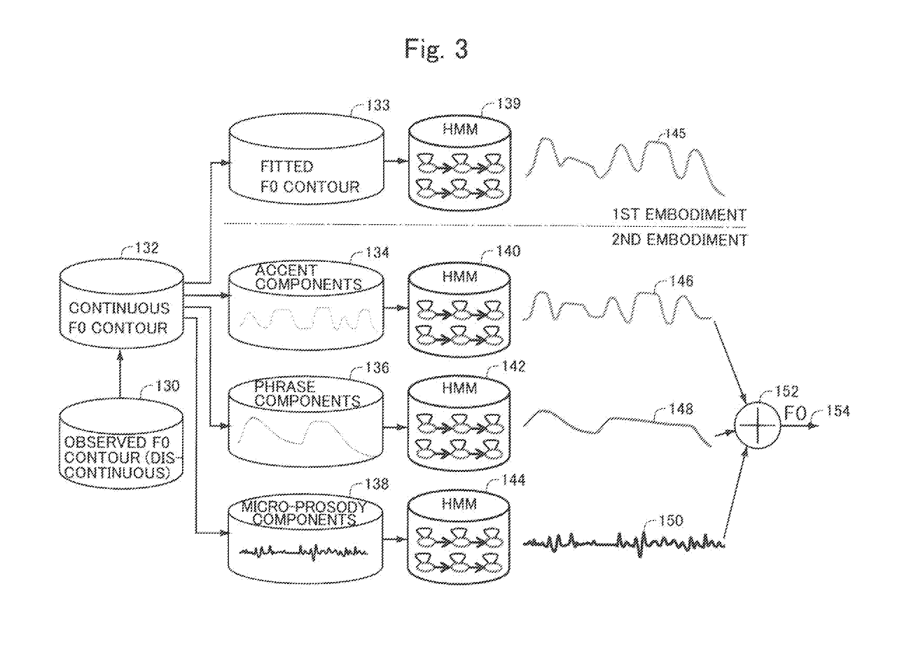

Referring to FIG. 3, the basic concept of the present invention will be described in the following. First, from a speech corpus, F0 contours are extracted and observed F0 contours 130 are formed. The observed F0 contours are generally discontinuous. By making such discontinuous F0 contours continuous and by smoothing them, a continuous F0 contour 132 is generated. Up to this process, conventional techniques can be used.

In the first embodiment, the continuous F0 contour 132 is fitted by synthesis of phrase and accent components, and an F0 contour 133 after fitting is estimated. The fitted F0 contour 133 is used as training data, and HMM is trained in the similar manner as in Non-Patent Literature 2, and HMM parameter after learning is stored in HMM storage device 139. Estimation of an F0 contour 145 can be done in the similar manner as in Non-Patent Literature 2. Here, a feature vector includes 40 mel-cepstrum parameters including 0th order, log of F0, and deltas and delta-deltas of these as elements.

In the second embodiment, the obtained continuous F0 contour 132 is decomposed to an accent component 134, a phrase component 136 and a micro-prosody component (hereinafter also referred to as “micro-component”) 138. HMMs 140, 142 and 144 for these components are trained separately. Here, time information must be shared by these three components. Therefore, as will be described later, a feature vector integrated to one in a multi-stream form for these three HMMs is used. The composition of used feature vector is the same as that of the first embodiment.

At the time of speech synthesis, using the result of text analysis, an accent component 146, a phrase component 148 and micro-component 150 of an F0 contour are generated individually, using HMM 140 for the accent component, HMM 142 for the phrase component and HMM 144 for the micro-component. By adding the resulting components using an adder 152, a final F0 contour 154 is generated.

Here, the continuous F0 contour must be represented by the accent component, the phrase component and the micro-component. It is noted, however, that the micro-component can be regarded as what is left when the accent component and the phrase component are subtracted from the F0 contour. Therefore, the problem is how to obtain the accent component and the phrase component.

It is straightforward and easy to understand to describe such features using target points. Both the accent component and the phrase component can be described by target points, where one accent or one phrase is described by three or four points. Of these four points, two represent low targets, and the remaining one or two represent high targets. These are referred to as target points. If there are two high targets, it is assumed that both have the same magnitude.

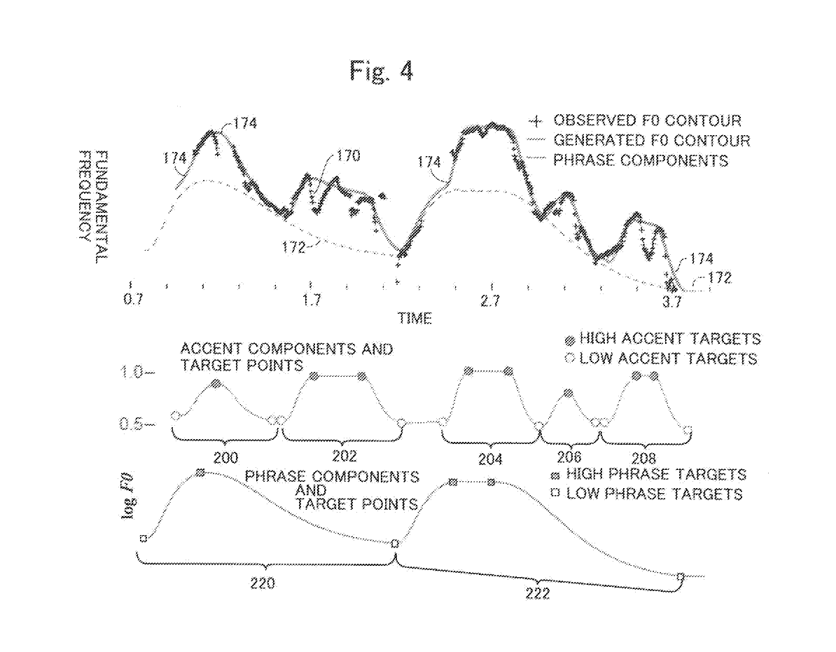

Referring to FIG. 4, by way of example, assume that a continuous F0 contour 174 is generated from an observed F0 contour 170. Further, the continuous F0 contour 174 is divided to phrase components 220 and 222 and accent components 200, 202, 204, 206 and 208, and each of these is described by target points. In the following, target points for the accent are referred to as accent target points, and those for the phrase are referred to as phrase targets. The continuous F0 contour 174 is represented as having the accent components placed over the phrase component 172.

The reason why the accent and phrase components are described by target points is to define non-linear interactions between the accent and phrase components in relation with each other and thereby to enable appropriate processing. It is relatively easy to find target points from an F0 contour. Transition of F0 between target points can be represented by Poisson process-based interpolation (Non-Patent Literature 3).

In order to process the non-linear interactions between the accent and phrase components, however, processing of these at a higher level is necessary. Therefore, here, the F0 contour is modeled using a two-level mechanism. On the first level, the accent and phrase components are generated by a mechanism using Poisson process. On the second level, these are synthesized by a mechanism using resonance, and thereby the F0 contour is generated. Here, the micro-component is obtained as a left over when the accent and phrase components are subtracted from the continuous F0 contour obtained at the start.

<Decomposition of F0 Contour Using Resonance>

F0 comes from vibration of vocal cords. Use of resonance mechanism has been known to be effective in operating the F0 contour. Here, mapping using resonance (Non-Patent Literature 4) is applied and latent interference between the accent and phrase components is processed by treating it as a type of topology deformations.

The resonance-based mapping between λ (frequency ratio square) and α (angle related to damping ratio) (hereinafter referred to as λ=f(α)) is defined as Equation (1) below.

$$\begin{matrix}\frac{λ}{1} = \frac{A ( λ , α ) - 1}{A ( 1 , α ) - 1} , 0 \leq λ < 1 , & ( 1 ) \\ where , A ( λ , α ) = \frac{1}{\sqrt{1 + {λ}^{2} {cos}^{2} 2 α - 2 λ {cos}^{2} 2 α}} & ( 2 )\end{matrix}$$

These equations indicate a resonance transformation. For simplicity of description, let α=f¹(λ) be the inverse mapping of the mapping above. When λ runs from 0 to 1, a takes values from ⅓ to 0 in falling order.

Let f₀ be any F₀ in a voice range specified by bottom frequency f_{0b} and top frequency f₀ₜ. With normalizing f0 to [0,1]

$${λ}_{f 0} := \frac{ln {f}_{0} - ln {f}_{{0}_{b}}}{ln {f}_{{0}_{t}} - ln {f}_{{0}_{b}}} , \qquad ( 3 )$$

A topological deformation between cubic and spherical objects as described in Non-Patent Literature 4 is applied to f₀. More specifically,

Define a cubic object with volume \sqrt{(0.5λ_{ƒ}_{₀})³}.

Map the cubic volumes to α, α_{f0}:=ƒ⁻¹\sqrt{(0.5λ_{ƒ}_{₀})³})

Map a reference F₀, ƒ₀ᵣε[ƒ₀_{_{b}}, ƒ₀_{ₜ}], to α similarly.

$${α}_{{f}_{{0}_{r}}} \text{:=} {f}^{- 1} ( \sqrt{{( 0.5 {λ}_{{f}_{{0}_{r}}} )}^{3}} ) .$$

Calculate

$${α}_{{f}_{{0}_{r}}} - {α}_{{f}_{0}} ,$$

mirror symmetry with respect

$$to {α}_{{f}_{{0}_{r}}} , thus {α}_{{f}_{{0}_{r}}} - {α}_{{f}_{0}}$$

having rising order.

Define a spherical object having volume

$$\begin{matrix}{φ}_{{f}_{0} \vert {f}_{{0}_{r}}} := \frac{4 π \times ( {α}_{{f}_{{0}_{r}}} - {α}_{{f}_{0}} )}{3} . & ( 4 ) \\ {φ}_{{f}_{0} \vert {f}_{{0}_{r}}} & \end{matrix}$$

is spherical because

$${α}_{{f}_{{0}_{r}}} - {α}_{{f}_{0}}$$

is cubic

Equation (4) indicates a decomposition of lnf₀ on time axis. More particularly, α_{f0r} is used to represent phrase components (treated as a baseline) and φ_{f0|f0r} accent components. When giving accent components by φ_{f0|f0r} and phrase components by αf₀ᵣ, lnf₀ can be calculated by Equation (5) below.

$$ln {f}_{0} = ln {f}_{0 b} + 2 {f}^{\frac{2}{3}} ( {α}_{f0r} - \frac{{φ}_{f 0 \vert f 0 r}}{4 π / 3} ) ( ln {f}_{0 t} - ln {f}_{0 b} ) \qquad ( 5 )$$

Accordingly, the resonance-based mechanism can be utilized to deal with the non-linear interactions between accent and phrase components while unifying them to give F0 contours.

<Resonance-Based Superpositional F0 Model>

A model of F0 contours as a function of time t can be represented in logarithmic scale as resonance-based superposition of accent components Ca(t) on phrase components Cp(t).

$$\begin{matrix}ln {F}_{0} ( t ) = ln {f}_{{0}_{b}} + 2 {f}^{\frac{2}{3}} ( α ( t ) ) ( ln {f}_{{0}_{t}} - ln {f}_{{0}_{b}} ) , & ( 6 ) \\ α ( t ) = {f}^{- 1} ( {( \frac{{C}_{p} ( t ) - ln {f}_{{0}_{b}}}{2 ( ln {f}_{{0}_{t}} - ln {f}_{{0}_{b}} )} )}^{\frac{3}{2}} ) - \frac{{C}_{a} ( t ) - 0.5}{10 \times 4 π / 3} , & ( 7 ) \\ {C}_{p} ( t ) = {\sum }_{i = 0}^{{I}_{p}} {γ}_{{p}_{i - 1}} + ( {γ}_{{p}_{i}} - {γ}_{{p}_{i - 1}} ) P ( t - {t}_{{p}_{i - 1}} , {t}_{{p}_{i}} - {t}_{{p}_{i - 1}} ) , & \\ {C}_{a} ( t ) = {\sum }_{i = 0}^{{I}_{a}} {γ}_{{a}_{i - 1}} + ( {γ}_{{a}_{i}} - {γ}_{{a}_{i - 1}} ) P ( t - {t}_{{a}_{i - 1}} , {t}_{{a}_{i}} - {t}_{{a}_{i}} - {t}_{{a}_{i - 1}} ) , & \\ P ( t , Δ t ) = 1 - {\sum }_{j = 0}^{k} \frac{{[ \frac{c ( k ) t}{Δ t} ]}^{j}}{j !} {e}^{- \frac{c ( k ) t}{Δ t}} , t \geq 0. & ( 8 )\end{matrix}$$

The model parameters for representing F0 contours of utterances are described as follows.

f₀ₜ: The top F0 of a speaker's voice frequency range.
f_{0b}: The bottom F0 of the voice frequency range.
Ip+1: The number of phrase targets for an utterance.
(tₚ_{ᵢ}, γₚ_{ᵢ}): The i-th phrase target; tₚᵢ is time and γₚᵢ magnitude.
Iₐ +1: The number of accent targets for the utterance.
(tₐ_{ᵢ}, γₐ_{ᵢ}): The i-th accent target; tₐᵢ is time and γₐᵢ magnitude.
F₀(t): Generated F0 contours (as a function of t).
ƒ(x): Resonance-based mapping by Equations (1) and (2).
ƒ⁻¹(x): Inverse mapping of f(x).
Cₚ(t): Phrase components generated by the phrase targets.
Cₐ(t): Accent components generated by the accent targets.
α(t): Synthesis of accent and phrase components.
P(t, Δt): A Poisson process-based filter
k: Sustaining a target.
c(k): Coefficients by solving the following equation

$${\sum }_{j \_ 0}^{k} \frac{{[ c ( k ) ]}^{j}}{j !} {e}^{- c ( k )} = 0.05 .$$

Normally, k=2, c(2)=6.3.
Factor “10” in Equation (7) scales Ca(t) into the α domain (0, ⅓).

Phrase target γₚᵢ is defined by F0 in the range [f_{0b}, f₀ₜ] in logarithmic scale. Accent target γₐᵢ is defined in (0, 1.5) with reference to zero 0.5. When accent target γₐᵢ<0.5, part of the accent components digs into under the phrase components (removes part of the phrase components), thus achieving final lowering of the F0 contour as observed in natural speech. Specifically, the accent components are superposed on the phrase components and at that time, part of the phrase components may be removed by the accent components.

<Model Parameter Estimation for F0 Superposition Model>

An algorithm is developed for estimating the parameters for target points (target parameters) from observed F0 contours of utterances in Japanese, given accentual phrase boundary information. Parameters f_{0b} and f₀ₜ are set to the F0 range of a set of observed F0 contours. In Japanese, an accentual phrase basically has an accent (accent type 0, 1, 2, . . . ). The algorithm is as follows.

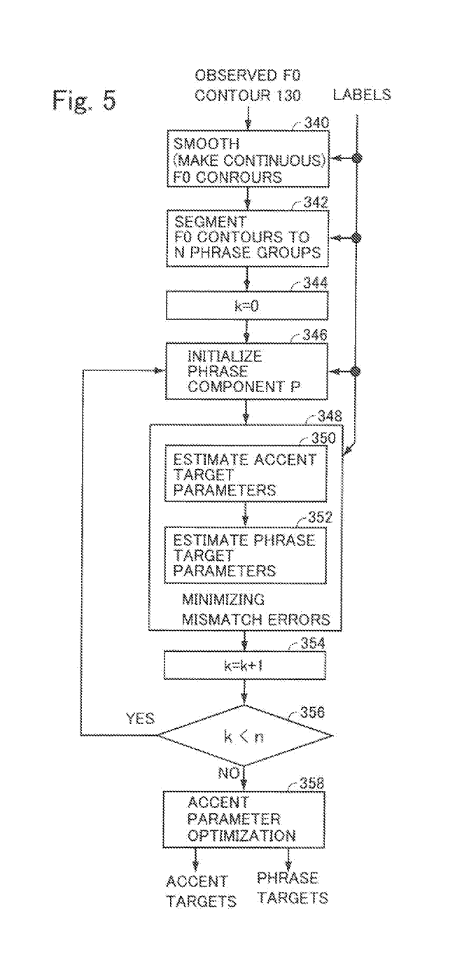

FIG. 5 is a program of a control structure shown in the form of a flowchart, which includes: the process of extracting F0 contours from observed F0 contours shown in FIG. 3; the process of generating a continuous F0 132 contour by smoothing and making continuous the extracted F0 contours; and the process of executing estimation of target parameters for representing the continuous F0 contour 132 as a sum of phrase and accent components both represented by target points, and generating an F0 contour 133 fitting the continuous F0 contour 132 with the estimated target parameters.

Referring to FIG. 5, this program includes: a step 340 of smoothing and making continuous observed discontinuous F0 contours and outputting a continuous F0 contour; and a step 342 of dividing the continuous F0 contour output at step 340 to N groups. Here, N is an arbitrary positive integer (for example, N=2, N=3 . . . ) designated in advance. Each of the divided group corresponds to a breath group. In the embodiment described in the following, the continuous F0 contour is smoothed using a long window, a designated number of portions where the F0 contour forms a trough is detected, and the F0 contour is divided at the detected positions.

The program further includes: a step 344 of inputting 0 to an iteration control variable k; a step 346 of initializing the phrase component P; a step 348 of estimating target parameters of accent component A and phrase component P to minimize an error between the continuous F0 contour and the phrase component P and accent component A; a step 354, following step 348, of adding 1 to the iteration control variable k; a step 356 of determining whether or not the value of variable k is smaller than a predetermined number of iteration n, and returning the flow of control to step 346 if the determination is YES; and a step 358, executed if the determination at step 356 is NO, of optimizing the accent target parameters obtained by the iteration of steps 346 to 356 and outputting the optimized accent targets and phrase targets. The difference between the F0 contour represented by these and the original continuous F0 contour corresponds to the micro-prosody component.

Step 348 includes: a step 350 of estimating accent target parameters; and a step 352 of estimating target parameters of phrase component P using the accent target parameters estimated at step 350.

Details of the algorithm described above are as follows. Description will be given with reference to FIG. 5.

(A) Preprocessing

Convert F0 contours into φ_{f0|f0r} with f₀ᵣ=f_{0b}, and then smooth them jointly using two window sizes (short term: 10 points, and long term: 80 points) (step 340), to suppress the effects of micro-prosody (the modification of F0 by phonetic segments) taking into account the general rise-(flat)-fall characteristics of Japanese accents. The smoothed F0 contours are converted back to F0 using Equation (5).

(B) Parameter Extraction

A segment between pauses longer than 0.3 seconds is regarded as a breath group, and a breath group is further divided to N groups using the F0 contours smoothed with long window (step 342). The following processes are conducted on each group. Here, a criterion of minimizing the absolute value of F0 errors is used. Then, in order to execute step 348 repeatedly, the iteration control variable k is set to 0 (step 344). (a) As an initial value, a three-target phrase component P having two low targets and one high target point is prepared (step 346). The phrase component P has, for example, the same shape as the left half of the graph of phrase component P at the lowest portion of FIG. 4. The timing of the high target point is set to the start of the second mora and the first low target point is shifted 0.3 seconds earlier. Further, the timing of the second low target is set to the end of the breath group. The initial values γₚᵢ of the phrase target magnitude are determined by using the smoothed F0 contours smoothed by using the long window.

At the next step 348, (b) accent components A are calculated by Equation (4) with the smoothed F0 contours and the current phrase components P. Then, an accent target point is estimated from the current accent components A. (c) The value γₐᵢ is adjusted into [0.9, 1.1] for all the high target points and [0.4, 0.6] for all the low target points, and the accent components A are re-calculated using the adjusted target points (step 350). (d) Phrase targets are re-estimated taking into account the current accent components A (step 352). (e) In order to repeat returning to (b) until a predetermined number is reached, 1 is added to variable k (step 354). (f) When the amount of absolute errors between the generated F0 contours and the smoothed F0 contours will be above a pre-defined threshold if a high phrase target is inserted, then a high phrase target is inserted, and then the control returns to (b). In order to determine whether or not the control should be returned to (b), 1 is added to variable k at step 354. If the value k has not yet reached n, the control returns to step 346. By this process, the phrase component P such as shown at the right half at the lower portion of FIG. 4 is obtained. If the value k has reached n, the accent parameters are optimized at step 358.

Parameter Optimization (step 358)

Accent target points are optimized by minimizing the errors between the generated and observed F0 contours, based on the estimated phrase component P. As a result, target points of phrase components P and accent components A, enabling generation of F0 contours fitting the smoothed F0 contours, are obtained.

As already described, the micro-prosody component M can be obtained from the portion corresponding to the difference between the smoothed F0 contours and the F0 contours generated from the phrase components P and accent components A.

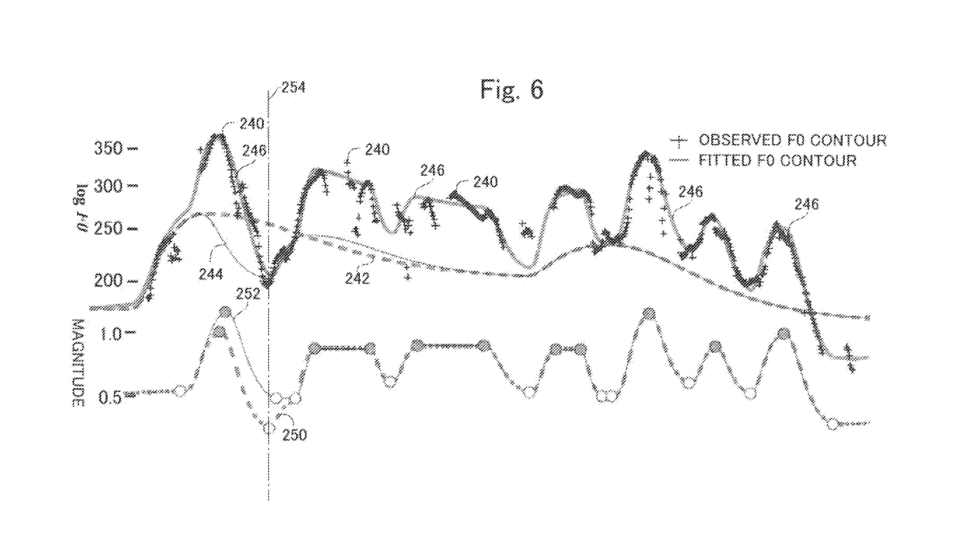

FIG. 6 shows examples of fitting observed F0 contours and the F0 contour by synthesizing phrase components P and accent components A, in accordance with the results of text analysis. FIG. 6 shows two cases superposed. In FIG. 6, the target F0 contour 240 (observed F0 contour) is represented by a sequence of signs “+”.

In the first case shown in FIG. 6, fitted F0 contour 246 is obtained by synthesizing phrase components 242 represented by a dotted line and accent components 250 also represented by a dotted line. In the second case, F0 contour 246 is obtained by synthesizing phrase components 244 represented by a thin line and accent components 252 also represented by a thin line.

As can be seen from FIG. 6, accent components 250 are almost identical to those of 252. It is noted, however, that the position of a high target point of the first accent element and the position of a low target point behind are lower than those of accent components 252.

The difference when the phrase and accent components 242 and 250 are combined and when the phrase and accent components 244 and 252 are combined mainly comes from the results of text analysis. If it is determined from the results of text analysis that there are two breath groups, phrase components 242 containing two phrases are adopted as the phrase components and synthesized with the accent components 252 obtained from the accent contour of Japanese. If it is determined from the results of text analysis that there are three breath groups, phrase components 244 and accent components 250 are synthesized.

In the example shown in FIG. 6, both phrase components 242 and 244 have a phrase boundary between the third accent element and the fourth accent element. On the other hand, assume that as a result of text analysis, it is determined that a third phrase boundary exists at the position indicated by a vertical line 254. In that case, phrase components 244 are adopted. Further, in order to represent the trough of F0 contour at the position indicated by vertical line 254, the high target point of the accent element positioned immediately before this position and the following low target point are dropped. By this approach, it becomes possible to realize highly accurate fitting of F0 contour even when it is determined from the results of text analysis that there exist three phrases. The reason for this is that the linguistic information as a base of utterance is represented by the utterance configuration and the accent type and that the linguistic information and the F0 contour clearly correspond.

### First Embodiment

### Configuration

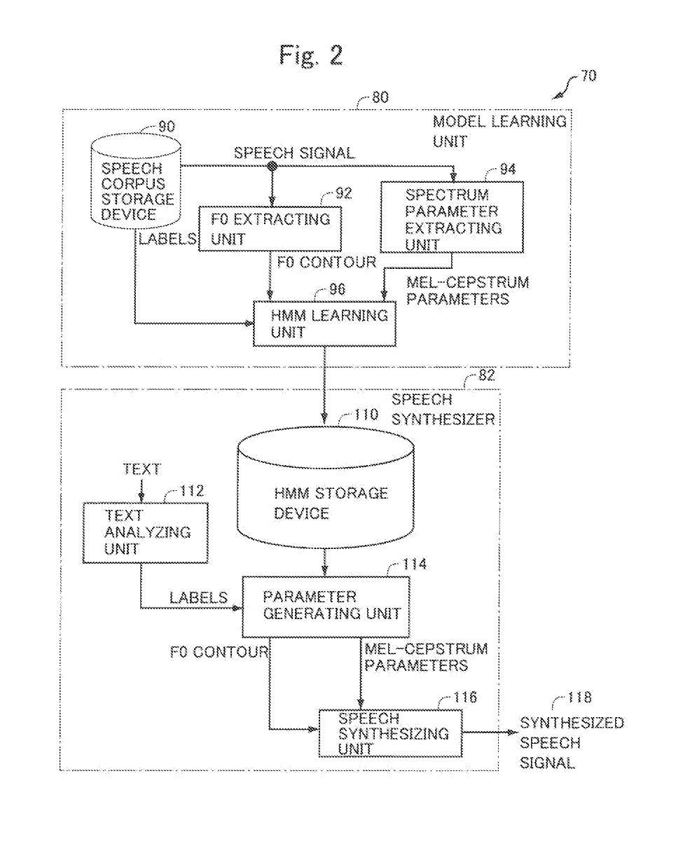

Referring to FIG. 7, an F0 contour synthesizer 359 in accordance with the first embodiment includes: a parameter estimating unit 366 estimating target parameters defining phrase components P and target parameters defining accent components A in accordance with the principle above, based on given accent boundaries on a continuous F0 contour 132 obtained by smoothing and making continuous the observed F0 contours 130 observed from each of a large number of speech signals included in a speech corpus; an F0 contour fitting unit 368 generating a fitted F0 contour fitting the continuous F0 contour by synthesizing the phrase and accent components estimated by parameter estimating unit 366; an HMM learning unit 369 conducting HMM learning in the conventional manner using the fitted F0 contour; and an HMM storage device 370 storing learned HMM parameters. The process of synthesizing F0 contour 372 using the HMM stored in HMM storage device 370 can be realized by a device similar to speech synthesizer 82 shown in FIG. 2.

<Operation>

Referring to FIG. 7, the system in accordance with the first embodiment operates in the following manner. By smoothing and making continuous each of the observed F0 contours 130, a continuous F0 contour 132 is obtained. Parameter estimating unit 366 decomposes the continuous F0 contour 132 to phrase components P and accent components A, and estimates respective target parameters using the method described above. F0 contour fitting unit 368 synthesizes the phrase components P and accent components A represented by the estimated target parameters, and obtains a fitted F0 contour that fits the observed F0 contour. The system conducts this operation on each of the observed F0 contours 130.

Using a large number of fitted F0 contours obtained in this manner, HMM learning unit 369 conducts learning of HMM in the similar manner as conventionally utilized. HMM storage device 370 stores HMM parameters after learning. Once the HMM learning is complete, when a text is given, the text is analyzed, and in accordance with the results of analysis, the F0 contour 372 is synthesized using the HMM stored in HMM storage device 370, in the conventional manner. By using the F0 contour 372 and a sequence of speech parameters such as mel-cepstrum selected in accordance with text phonemes, for example, speech signals can be obtained in the similar manner as used conventionally.

<Effects of the First Embodiment>

HMM learning was conducted in accordance with the above-described first embodiment, and speeches synthesized by using the F0 contours synthesized by using the learned HMM were subjected to subjective evaluation test (preference assessment).

The experiments for the evaluation test were conducted using 503 utterances included in a speech corpus ATR 503 set, which was prepared by the applicant and is open to the public. Out of 503 utterances, 490 were used for HMM learning, and the rest were used for testing. Utterance signals were sampled at 16 kHz sampling rate and spectral envelopes were extracted by STRAIGHT analysis with 5 milli-seconds frame shift. The feature vector consists of 40 mel-cepstrum parameters including the 0-th parameter, log F0, and their delta and delta-deltas. A five-state left-to-right model topology was used.

The following four F0 contours were prepared for HMM learning.

(1) F0 contours obtained from speech waveforms (original).

(2) F0 contours generated by the first embodiment (Proposed).

(3) F0 contours generated by combining voiced regions from the original contours and unvoiced regions generated by the method of the first embodiment (Prop.+MP (Micro-Prosody)).

(4) F0 contours generated by combining voiced regions from the original contours and spline-based interpolation for the unvoiced region (Spl+MP). Of the four contours, (2) to (4) are continuous F0 contours. It should be noted that (2) excludes both micro-prosody and F0 extraction errors, but (3) and (4) include both of them.

As in the conventional art, MSD-HMM learning was conducted for the original. For (2) to (4), MSD-HMM learning was conducted by adding the continuous F0 contours (and their deltas and delta-deltas) as the fifth stream, with the weight set to 0. Consequently, continuous F0 contours result for (2) to (4).

At the time of speech synthesis, continuous F0 contours are first synthesized by the continuous F0 contour HMM, and their voiced/unvoiced decision is taken from MSD-HMM.

In a preference evaluation test, four pairs of F0 contours were selected from the four F0 contours prepared in the above-described manner, and five participants were asked to determine which of these generated speech signals was more natural. The participants were all native Japanese speakers. The four contour pairs were as follows.

(1) Proposed vs. Original

(2) Proposed vs. Prop+MP

(3) Proposed vs. Spl+MP

(4) Proposed+MP vs. Spl+MP.

Nine sentences, which were not used for learning, were used for evaluation by the participants. Nine wave file pairs were duplicated, and order of wave files of respective pairs was swapped. The final 72 (4×9×2) wave file pairs were provided to the participants in random order, and the participants were asked to select which is preferable or no preference.

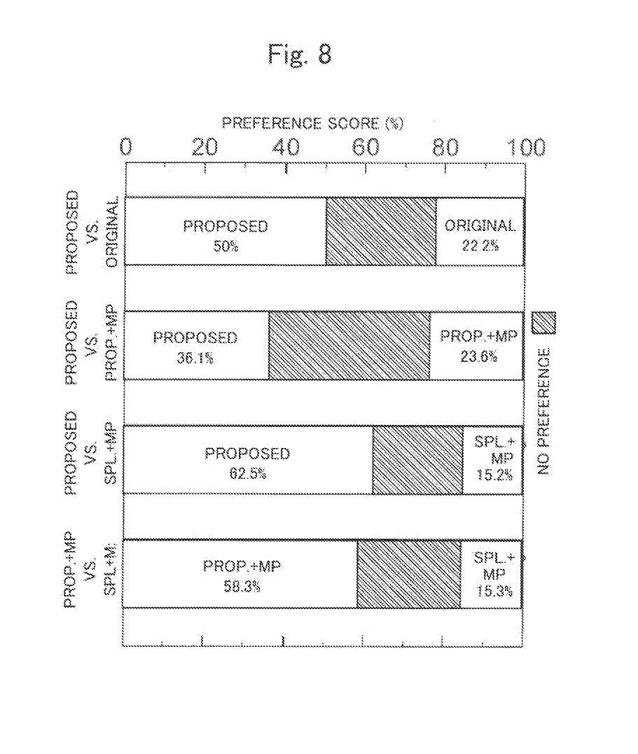

The results of evaluation by the participants are as shown in FIG. 8. As is apparent from FIG. 8, the synthesized speeches using the F0 contour synthesized by the Proposed method were preferred to those using the observed F0 contours (Proposed vs. Original). Adding micro-prosody to the Proposed method does not improve speech naturalness (Proposed vs. Prop+MP). As compared with the synthesized speeches obtained from spline-based interpolation of continuous F0 contours, the speeches of Proposed method were more frequently preferred (Proposed vs. Spl+MP). The last two observations were re-confirmed by the result for Prop+MP vs. Spl+MP.

### Second Embodiment

In the first embodiment, the phrase components P and accent components A are represented by target points, and F0 contour fitting is done by synthesizing these. The idea of using target points, however, is not limited to the first embodiment. In the second embodiment, the F0 contours observed in accordance with the method described above are discomposed to phrase components P, accent components A and micro-prosody components M, and HMM learning is conducted for time-change contours of each of these. In generating F0, time-change contours of phrase components P, accent components A and micro-prosody components M are obtained by using learned HMMs, and further, these are synthesized to estimate F0 contours.

<Configuration>

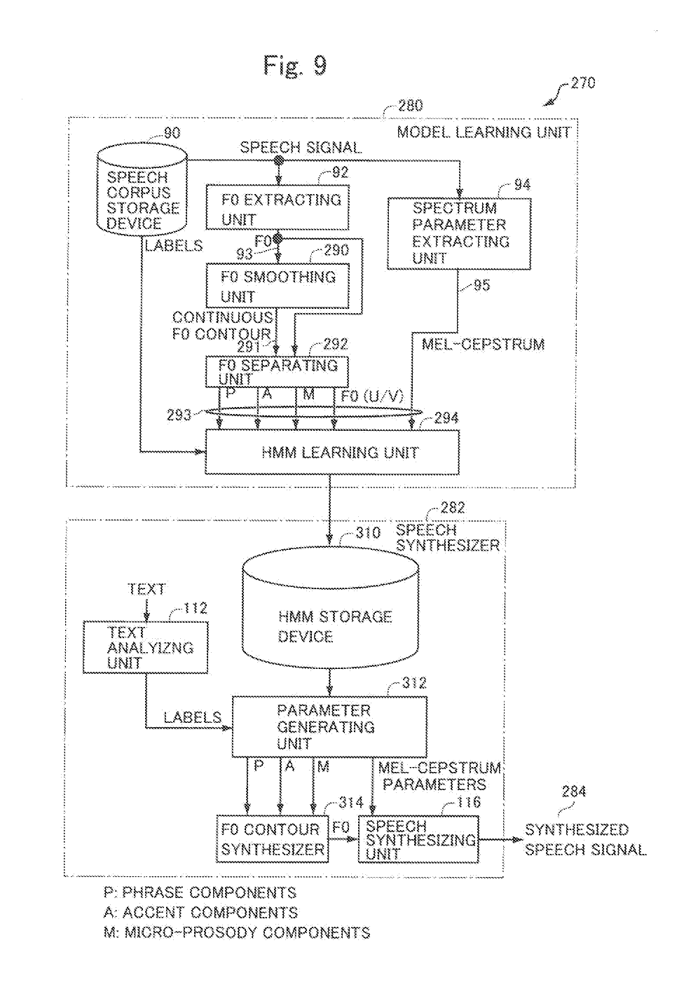

Referring to FIG. 9, a speech synthesizing system 270 in accordance with the present embodiment includes: a model learning unit 280 conducting HMM learning for speech synthesis; and a speech synthesizer 282, when a text is input, synthesizing speeches thereof and outputting as synthesized speech signal 284, using the HMM learned by model learning unit 280.

Similar to the model learning unit 80 of conventional speech synthesizing system 70 shown in FIG. 2, model learning unit 280 includes a speech corpus storage device 90, an F0 extracting unit 92 and a spectrum parameter extracting unit 94. It is noted, however, that in place of HMM learning unit 96 of model learning unit 80, model learning unit 280 includes: an F0 smoothing unit 290 smoothing and making continuous discontinuous F0 contours 93 output from F0 extracting unit 92, and outputting a continuous F0 contour 291; and an F0 separating unit 292, separating the continuous F0 contour output from F0 smoothing unit 290 to phrase components P, accent components A and micro-prosody components M, generating time-change contours of each component and outputting these together with discontinuous F0 contours 93 having voiced/unvoiced information. Model learning unit 280 further includes a HMM learning unit 294 conducting statistical learning of HMM, based on phoneme context labels corresponding to training data vector 293 read from speech corpus storage device 90, using multi-stream type HMM training data vector 293 (40 mel-cepstrum parameters including 0-th order, above-mentioned time-change contours of three components of F0, and deltas and delta-deltas of these) consisting of mel-cepstrum parameters 95 output from spectrum parameter extracting unit 94 and the outputs from F0 separating unit 292.

Speech synthesizer 282 includes: a HMM storage unit 310 storing HMM learned by HMM learning unit 294; text analyzing unit 112 same as that shown in FIG. 2; a parameter generating unit 312, estimating and outputting time-change contours of optimal (having high probability that it is the original speech as the origin of label sequence) phrase component P, accent component A and micro-prosody component M and mel-cepstrum parameters, using the HMM stored in HMM storage unit 310; an F0 contour synthesizer 314, synthesizing the time-change contours of phrase component P, accent component A and micro-prosody component M output from parameter generating unit 312 and thereby generating and outputting F0 contours; and a speech synthesizing unit 116 same as that shown in FIG. 2, synthesizing speeches from the mel-cepstrum parameters output from parameter generating unit 312 and the F0 contours output from F0 contour synthesizer 314.

The control structure of a computer program for realizing F0 smoothing unit 290, F0 separating unit 292 and HMM learning unit 294 shown in FIG. 9 is the same as that shown in FIG. 5.

<Operation>

Speech synthesizing system 270 operates in the following manner. Speech corpus storage device 90 stores a large amount of utterance signals. Utterance signals are stored frame by frame, and a phoneme context label is appended to each phoneme. F0 extracting unit 92 outputs discontinuous F0 contours 93 from utterance signals of each utterance. F0 smoothing unit 290 smoothes discontinuous F0 contour 93, and outputs a continuous F0 contour 291. F0 separating unit 292 receives the continuous F0 contour 291 and the discontinuous F0 contours 93 output from F0 extracting unit 92, and in accordance with the method described above, applies to HMM learning unit 294 training data vectors 293 each including, for each frame, time change contour of phrase component P, time change contour of accent component A, time change contour of micro prosody component M, information F0 (U/V) indicating whether each frame is a voiced or unvoiced segment, obtained from discontinuous F0 contour 93, and mel-cepstrum parameter calculated for each frame of speech signals of each utterance calculated by spectrum parameter extracting unit 94.

For each frame of speech signals of each utterance, HMM learning unit 294 forms, from the labels read from speech corpus storage device 90, training data vectors 293 given from F0 separating unit 292 and the mel-cepstrum parameter from spectrum parameter extracting unit 94, the feature vectors of the configuration as described above, and using these as training data, conducts statistical learning of HMM such that when a context label of a frame as an object of estimation is given, probabilities of values of mel-cepstrum parameters and the time change contours of phrase components P, accent components A and micro-prosody components M of the frame are output. When HMM learning is completed for all utterances in speech corpus storage device 90, the parameters of HMM are stored in HMM storage unit 310.

When a text as an object of speech synthesis is given, speech synthesizer 282 operates in the following manner. Text analyzing unit 112 analyzes the given text, generates a sequence of context labels representing the speech to be synthesized, and applies it to parameter generating unit 312. For each label included in the label sequence, parameter generating unit 312 generates a sequence of parameters (time change contours of phrase component P, accent component A and micro-prosody component M as well as mel-cepstrum parameters) having the highest probability of being the speech generating such a label sequence, and applies the phrase component P, accent component A and micro-prosody component M to F0 contour synthesizer 314 and applies the mel-cepstrum parameters to speech synthesizing unit 116, respectively.

F0 contour synthesizer 314 synthesizes time change contours of phrase component P, accent component A and micro-prosody component M and applies the result as an F0 contour to speech synthesizing unit 116. In the present embodiment, at the time of HMM learning, the phrase component P, the accent component A and the micro-prosody component M are all in logarithmic expression. Therefore, at the time of synthesis by the F0 contour synthesizer 314, these are converted from logarithmic expression to common frequency components, and added to each other. Here, since zero-points of respective components have been shifted at the time of learning, an operation to turn the zero-point back is also necessary.

Speech synthesizing unit 116 synthesizes the speech signals in accordance with the F0 contours output from F0 contour synthesizer 314, then performs signal processing that corresponds to modulation of the resulting signal in accordance with the mel-cepstrum parameters applied from parameter generating unit 312, and outputs synthesized speech signals 284.

<Effects of the Second Embodiment>

In the second embodiment, F0 contours are decomposed to the phrase components P, the accent components A and the micro-prosody components M, and separate HMMs are trained using these. At the time of speech synthesis, based on the result of text analysis, the phrase components P, the accent components A and the micro-prosody components M are separately generated using the HMMs. Further, thus generated phrase components P, accent components A and micro-prosody components M are synthesized and thereby F0 contours are generated. Using F0 contours obtained in this manner, natural utterance can be obtained as in the first embodiment. Further, since the accent components A and the F0 contours correspond clearly, it is easy to put a focus on a specific word, for example, by making larger a range of accent component A for the specific word. This can be seen as an operation of dropping the frequency of a component immediately preceding the vertical line 254 of accent component 250 shown in FIG. 6 and an operation of dropping the frequency of trailing F0 contours of accent components 250 and 252 of FIG. 6.

[Computer Implementation]

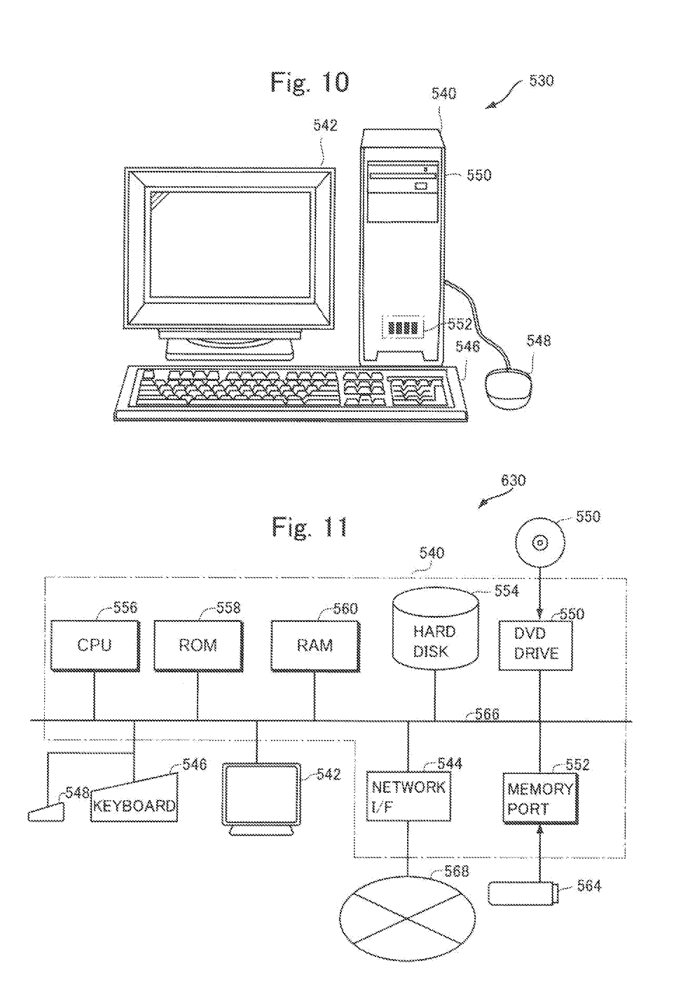

The F0 contour synthesizers in accordance with the first and second embodiments can both be implemented by computer hardware and the above-described computer program running on the computer hardware. FIG. 10 shows an appearance of computer system 530 and FIG. 11 shows an internal configuration of computer system 530.

Referring to FIG. 10, the computer system 530 includes a computer 540 having a memory port 552 and a DVD (Digital Versatile Disc) drive 550, a keyboard 546, a mouse 548 and a monitor 542.

Referring to FIG. 11, in addition to memory port 552 and DVD drive 550, computer 540 includes a CPU (Central Processing Unit) 556, a bus 566 connected to CPU 556, memory port 552 and DVD drive 550, a read only memory (ROM) 558 for storing a boot program and the like, a random access memory (RAM) 560 connected to bus 566 and storing program instructions, a system program and work data, and a hard disk 554. Computer system 530 further includes a network interface (I/F) 544 providing a connection to a network 568, enabling communication with other terminals.

The computer program causing computer system 530 to function as various functional units of F0 contour synthesizer in accordance with the above-described embodiments is stored in a DVD 562 or removable memory 564 loaded to DVD drive 550 or memory port 552, and transferred to hard disk 554. Alternatively, the program may be transmitted to computer 540 through network 568 and stored in hard disk 554. The program is loaded to RAM 560 at the time of execution. The program may be directly loaded to RAM 560 from removable memory 564, or through network 568.

The program includes a sequence of instructions consisting of a plurality of instructions causing computer 540 to function as various functional units of F0 contour generating unit in accordance with the embodiments above. Some of the basic functions necessary to cause computer 540 to operate in this manner may be provided by the operating system running on computer 540, by a third-party program, or various programming tool kits or program library installed in computer 540. Therefore, the program itself may not include all functions to realize the system and method of the present embodiments. The program may include only the instructions that call appropriate functions or appropriate program tools in the programming tool kits in a controlled manner to attain a desired result and thereby to realize the functions of the system described above. Naturally the program itself may provide all necessary functions.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is applicable to providing services using speech synthesis and to manufacturing of devices using speech synthesis.

### REFERENCE SIGNS LIST

30 F0 contour generation process model
40 phrase command
42 phrase control mechanism
44 accent command
46 accent control mechanism
48, 152 adder
50 F0 contour
70, 270 speech synthesizing system
80, 280 model learning unit
90 speech corpus storage device
92 F0 extracting unit
93 discontinuous F0 contours
94 spectrum contour extracting unit
95 mel-cepstrum parameter
96, 294, 369 HMM learning unit
110, 310, 139, 370 HMM storage device
112 text analyzing unit
114 parameter generating unit
116 speech synthesizing unit
130, 170 observed F0 contour
132, 174, 291 continuous F0 contour
134, 146, 200, 202, 204, 206, 208, 250, 252 accent component
136, 148, 220, 222, 242, 244 phrase component
138, 150 micro-prosody component
140, 142, 144 HMM
48, 152 adder
154, 240, 246 F0 contour
172 phrase component
290 F0 smoothing unit
292 F0 separating unit
293 training data vector
312 parameter generating unit
314, 359 F0 contour synthesizer
366 parameter estimating unit
368 F0 contour fitting unit

1. A quantitative F0 contour generating device, comprising:
means for generating, for an accent phrase of an utterance obtained by text analysis, accent components of an F0 contour using a given number of target points;
means for generating phrase components of the F0 contour using a limited number of target points, by dividing the utterance to groups each including one or more accent phrases, in accordance with linguistic information including an utterance structure; and
means for generating an F0 contour based on said accent components and said phrase components.

2. A quantitative F0 contour generating method, comprising the steps of:
generating, for an accent phrase of an utterance obtained by text analysis, accent components of an F0 contour using a given number of target points;
generating phrase components of the F0 contour using a limited number of target points, by dividing the utterance to groups each including one or more accent phrases, in accordance with linguistic information including an utterance structure; and
generating an F0 contour based on said accent components and said phrase components.

3.-4. (canceled)

5. A model learning device for F0 contour generation, comprising:
F0 contour extracting means for extracting an F0 contour from a speech data signal;
parameter estimating means for estimating target parameters representing phrase components and target parameters representing accent components, for representing an F0 contour fitting the extracted F0 contour by superposition of phrase components and accent components; and
model learning means, performing F0 generation model learning, using a continuous F0 contour represented by the target parameters of phrase components and the target parameters of accent components estimated by said parameter estimating means as training data.

6. The model learning device according to claim 5, wherein
said F0 generation model includes a generation model for generating phrase components and a generation model for generating accent components; and
said model learning means includes means for performing learning of said generation model for generating phrase components and said generation model for generating accent components, respectively using, as training data, a time change contour of phrase components represented by target parameters of the phrase components and a time change contour of accent components represented by target parameters of the accent components, estimated by said parameter estimating means.

7. A model learning method for F0 contour generation, comprising the steps of:
F0 contour extracting step of extracting an F0 contour from a speech data signal;
parameter estimating step of estimating target parameters representing phrase components and target parameters representing accent components, for representing an F0 contour fitting the extracted F0 contour by superposition of phrase components and accent components; and
model learning step of performing F0 generation model learning, using a continuous F0 contour represented by the target parameters of phrase components and the target parameters of accent components estimated by said parameter estimating means as training data.

8. The model learning method according to claim 7, wherein
said F0 generation model includes a generation model for generating phrase components and a generation model for generating accent components; and
said model learning step includes the step of performing learning of said generation model for generating phrase components and said generation model for generating accent components, respectively using, as training data, a time change contour of phrase components represented by target parameters of the phrase components and a time change contour of accent components represented by target parameters of the accent components, estimated at said parameter estimating step.
